(19) United States
(12) Patent Application Publication
(10) Pub. No.: US 2014/0334506 A1
(43) Pub. Date: Nov. 13, 2014

(54) LIGHT DEFLECTOR AND LASER LIGHT SOURCE INCLUDING SAME

(71) Applicant: Showa Optronics Co., Ltd., Tokyo (JP)

(72) Inventor: Minoru Kadoya, Tokyo (JP)

(73) Assignee: Showa Optronics Co., Ltd., Tokyo (JP)

(21) Appl. No.: 14/191,333

(22) Filed: Feb. 26, 2014

(30) Foreign Application Priority Data
May 7, 2013 (JP) 2013-097527

(51) Int. Cl. H01S 3/13; H01S 3/00; G02F 1/29

(52) U.S. Cl. CPC H01S 3/1305; G02F 1/29; H01S 3/13; H01S 3/0092
USPC 372/22; 359/298; 372/26

(57) ABSTRACT

A light deflector for deflecting a propagation direction of laser includes: a first metallic piece and a second metallic piece spaced apart from each other; and a transparent medium and an electronic cooling element disposed between the first metallic piece and the second metallic piece such that each of the transparent medium and the electronic cooling element is in contact with the first metallic piece and the second metallic piece. The electronic cooling element creates a temperature difference between the first metallic piece and the second metallic piece to vary a refractive index of the transparent medium.

### TECHNICAL FIELD

The present invention relates to a light deflector that does not include a mechanically movable part and does not require a high voltage for operation, and a laser light source using the light deflector for correcting a deviation of the optical axis.

### BACKGROUND OF THE INVENTION

In a laser light source including mirrors for forming a laser resonator and minors for causing laser light to propagate properly by reflecting the laser light at appropriate points, when a distortion is generated in a housing, the distortion may cause a slight change in an angle of some mirror(s), and this may cause a deviation in the optical axis of laser light propagating inside the laser light source, which in turn may lead to a reduction in laser output and/or deterioration in laser beam quality.

This deviation of the optical axis may be caused by a change in the housing temperature due to heat generated by the laser light source itself or a change in the environment temperature, where the amount of heat generated from the laser light source may change over time as an amount of energy to be supplied to the excitation source to achieve a given laser power tends to increase over time.

Further, the deviation of the optical axis may also be caused by a stress applied to the laser light source from outside, such as when the laser light source set up at a certain location or incorporated into a laser application system is mounted on a distorted surface. The distortion of the surface on which the laser light source is mounted may be caused even after the mounting of the laser light source due to a change in the environment temperature or due to the heat generated from the laser application system into which the laser light source is incorporated.

In one method of correcting the optical axis deviation, a Risley prism pair which includes a pair of wedge-shaped glass plates is used. JP2011-216552A discloses a multi-stage amplification laser system in which a Risley prism pair is rotated by a motor to adjust the optical axis. JP2011-53370A and JPH9-153654A disclose using a piezo element to enable adjustment of an angle between an end mirror and an output mirror of a laser resonator. Further, JP2011-53370A indicates using an electrically driven cylinder instead of the piezo element. JPH6-66491B discloses using a stepping motor. In “Quantum Electronics,” by Amnon Yariv, 3rd edition, John Wiley & Sons, 1989, description is given to deflection of light using an electro-optic effect.

In general, an optical axis deviation caused by a distortion of the housing of the laser light source occurs at a very slow rate, except for the time when the laser light source is set up. Further, when the laser light source is set up anew, it is often tolerated for the initial optical axis adjustment work to take several minutes. The light deflectors used in the aforementioned prior art systems may have a sufficient performance to correct an optical axis deviation in a laser light source. However, in a case where the purpose of use is limited to adjustment of an optical axis of a laser light source, the time responsiveness and/or the range of deflection angle provided by the light deflectors used in the foregoing systems may be beyond what is required.

Further, in a case where the light deflectors of the foregoing prior art systems are used in adjustment of an optical axis of a laser light source, there may be problems such as that the light deflectors requiring a high voltage and/or high frequency tend to result in a higher cost, and that the light deflectors using a motor, which is a movable part, can adversely affect the laser characteristics during an operation of the laser light source and/or are inappropriate for incorporation into a laser light source in which outgassing likely creates a problem. Further, the prior art light deflectors are large in size and high in cost.

### SUMMARY OF THE INVENTION

In view of the aforementioned problems in the prior art, a primary object of the present invention is to provide a light deflector having a simple structure without a movable part. Another object of the present invention is to provide a laser light source that utilizes such a light deflector to correct the optical axis of the laser light propagating inside the laser light source, to thereby achieve a stable output.

To achieve the aforementioned objects, one aspect of the present invention provides a light deflector for deflecting a propagation direction of laser, including: a first metallic piece and a second metallic piece spaced apart from each other; and a transparent medium and an electronic cooling element disposed between the first metallic piece and the second metallic piece such that each of the transparent medium and the electronic cooling element is in contact with the first metallic piece and the second metallic piece, wherein the electronic cooling element creates a temperature difference between the first metallic piece and the second metallic piece to vary a refractive index of the transparent medium.

In a preferred embodiment, at least one of surfaces of the transparent medium other than two surfaces thereof in contact with the first metallic piece and the second metallic piece, respectively, has a dielectric multilayer coating formed thereon, the coating having a low reflectance for incident laser light.

Further, one of surfaces of the transparent medium other than two surfaces thereof in contact with the first metallic piece and the second metallic piece, respectively, may have a dielectric multilayer coating formed thereon, the coating having a high reflectance for incident laser light.

It is preferred that one of surfaces of the transparent medium other than two surfaces thereof in contact with the first metallic piece and the second metallic piece, respectively, is formed as a reflection surface that reflects laser light propagating in the transparent medium, and a surface of the transparent medium from which laser light reflected by the reflection surface is output has a dielectric multilayer coating formed thereon, the coating having a low reflectance for the laser light.

Preferably, the light deflector may further include: a first temperature sensor embedded in the first metallic piece; a second temperature sensor embedded in the second metallic piece; and an electric power controller configured to set a temperature difference between the first metallic piece and the second metallic piece, and control electric power supplied to the electronic cooling element such that a difference between a value measured by the first temperature sensor and a value measured by the second temperature sensor approaches the set temperature difference.

According to another aspect of the present invention, there is provided a laser light source including the foregoing light deflector, wherein the light deflector is disposed on an optical path of the laser light.

Preferably, the laser light source further includes: a beam position detector that detects a deviation of a position of laser light propagating on an optical path from a reference position; and a control unit configured to control the light deflector based on a signal output from the beam position detector so as to reduce the deviation from the reference position.

More preferably, the laser light source further includes: a single longitudinal mode laser configured to output a continuous wave light; and an external resonator configured to perform external resonator-type second harmonic generation using output light from the single longitudinal mode laser as a fundamental wave, wherein the light deflector is disposed on an optical path between the single longitudinal mode laser and the external resonator.

More preferably, the beam position detector includes a photo detector that detects a position of part of the fundamental wave that leaks from the external resonator without being wavelength-converted, and the control unit is configured to control the light deflector based on a signal from the photo detector corresponding an amount of deviation of the detected position from the reference position so as to reduce the amount of deviation.

The light deflector according to one aspect of the present invention is capable of fine-adjusting the deflection angle in a simple structure including no movable part. Thus, the light deflector is particularly suitable for incorporation into a laser light source. Further, in addition to the simple structure, the light deflector has an advantage that it can be operated without use of a high voltage, and therefore, can be implemented at a low cost.

Further, the laser light source according to another aspect of the present invention includes the foregoing light deflector, and thus, even when a deviation of an optical axis is generated when the laser light source is set up or when a housing of the laser light source is distorted due to a change in the environment temperature, for example, it is possible to correct the optical axis automatically or manually by providing an appropriate electric signal to the light deflector from outside without need for accessing the inside of the laser light source.

### BRIEF DESCRIPTION OF THE DRAWINGS

Now the present invention is described in the following in terms of preferred embodiments thereof with reference to the appended drawings, in which:

FIG. 1 is a perspective view of a light deflector according to an embodiment of the present invention;

FIG. 2 is a cross-sectional view of the light deflector shown in FIG. 1;

FIGS. 3A-3C are schematic diagrams showing various embodiments of a transparent medium of the light deflector shown in FIG. 1;

FIG. 4 is a block diagram showing a circuit for driving the light deflector shown in FIG. 1;

FIG. 5 is a diagram showing a general structure of a laser light source including the light deflector shown in FIG. 1; and

FIG. 6 is a block diagram showing a circuit for driving the laser light source shown in FIG. 5.

### DETAILED DESCRIPTION OF THE PREFERRED EMBODIMENTS

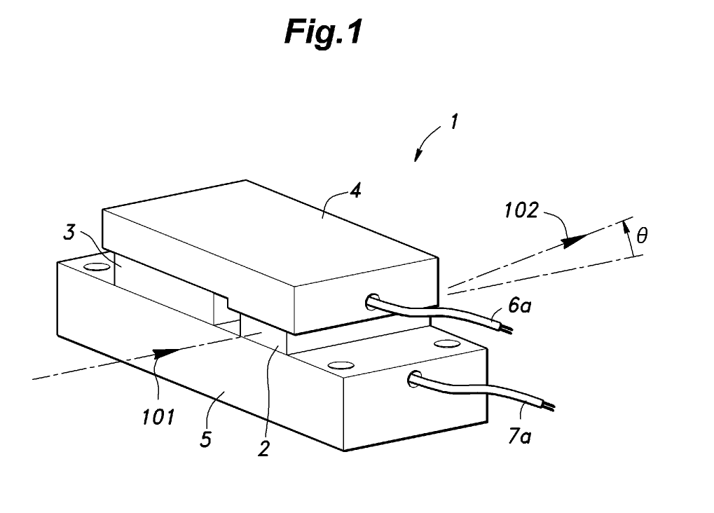

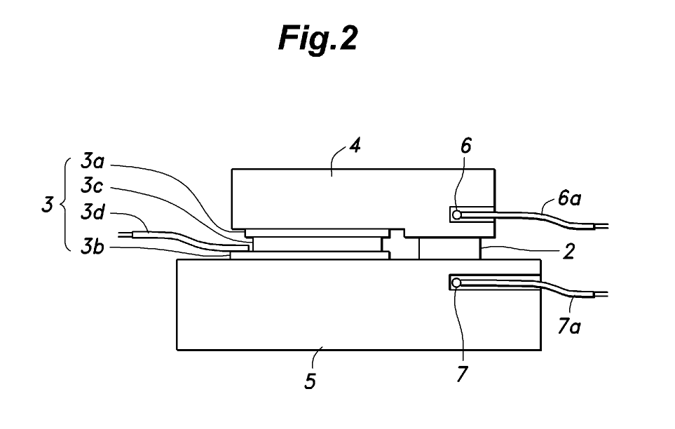

FIG. 1 is a perspective view of a light deflector 1 according to an embodiment of the present invention, and FIG. 2 is a cross-sectional view of the light deflector 1 shown in FIG. 1. The deflector 1 includes a transparent medium 2 and an electronic cooling element (thermo-electric cooler) 3 which are arranged next to each other and interposed between a first metallic piece 4 and a second metallic piece 5 each made of brass. The first metallic piece 4 has a first temperature sensor 6 embedded therein and the second metallic piece 5 has a second temperature sensor 7 embedded therein to monitor the temperature. Each of the first temperature sensor 6 and the second temperature sensor 7 is embodied as a thermistor having an electric resistance that varies with temperature. The light deflector 1, excluding electrodes 3d of the electronic cooling element 3 and electrodes 6a and 7a of the temperature sensors 6 and 7, has a dimension of 30 mm×10 mm×10 mm.

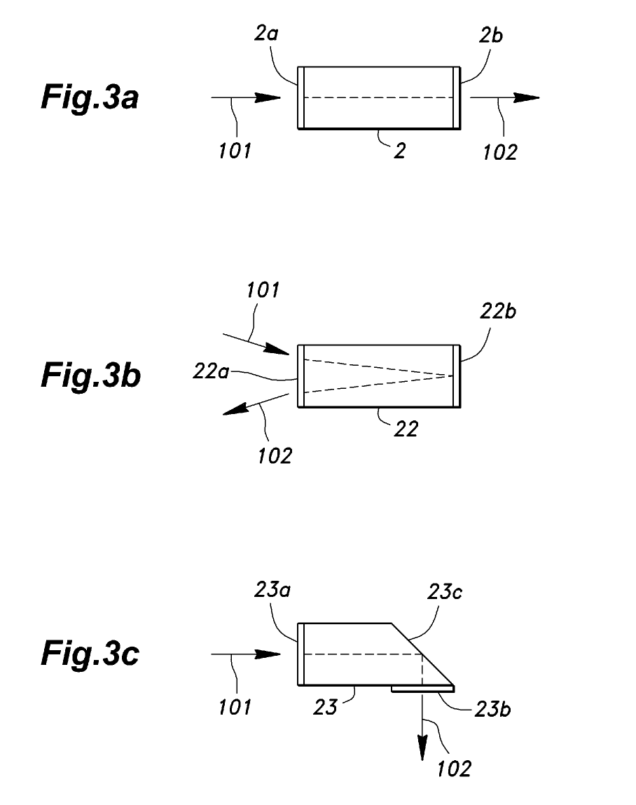

The transparent medium 2 is made of a synthetic quartz glass and is rectangular in shape having a dimension of 2 mm×4 mm×10 mm. FIGS. 3A-3C are schematic diagrams showing various embodiments of the transparent medium 2 of the light deflector 1, each showing the transparent medium 2 as seen from above (from the side facing the first metallic piece 4). As shown in FIG. 3A, in the present embodiment, dielectric multilayer coatings 2a and 2b having a low reflectance are formed on an end surface of the transparent medium 2 through which laser light 101 enters and on an end surface of the same from which laser light 102 exits, respectively. The laser light 101 incident on one end of the light deflector 1 as shown in FIG. 3A is deflected as it travels through the transparent medium 2, such that the laser light 102 having passed through the transparent medium 2 is deflected upward or downward in a direction perpendicular to the sheet of the drawing.

As shown in FIG. 2, the electronic cooling element 3 includes a number of semiconductor elements 3c formed of p-type and n-type semiconductors interposed between a pair of electrically insulating ceramic plates 3a and 3b. The electronic cooling element 3 further includes a pair of electrodes 3d such that when a DC current is caused to flow between the pair of electrodes 3d, the electronic cooling element 3 functions to provide a temperature difference ΔT between the ceramic plate 3b and the ceramic plate 3a owing to the Peltier effect. Thus, when the ceramic plate 3b of the electronic cooling element 3 is connected with a heat sink, for example, the ceramic plate 3a of the electronic cooling element 3 can be heated or cooled relative to the heat sink (or relative to the ceramic plate 3b) by controlling the direction of the DC current flowing between the electrodes 3d.

When the light deflector 1 is used, the light deflector 1 is placed in a laser housing, such that the laser light 101, which is to be deflected by the light deflector 1, enters and passes through the transparent medium 2 in a direction different from (in FIG. 1, perpendicular to) the direction in which the transparent medium 2 and the electronic cooling element 3 are arranged, and the second metallic piece 5 of the light deflector 1 is secured to a mounting surface of the housing made of a material having a good thermal conductivity, such as a metal, by means of screws.

In this state, if an electric current is caused to flow through the electronic cooling element 3 such that the temperature of the first metallic piece 4 becomes higher than the temperature of the second metallic piece 5, the temperature of a portion of the transparent medium 2 on the side of the first metallic piece 4 becomes higher than the temperature of a portion of the transparent medium 2 on the side of the second metallic piece 5. In the transparent medium 2, a portion having a higher temperature tends to have a higher refractive index, and in a state when a sufficient time has lapsed to reach a steady state, the refractive index in the transparent medium 2 increases linearly from the side on the second metallic piece 5 toward the side on the first metallic piece 4. Therefore, the laser light 102 that has passed through the transparent medium 2 is deflected upward or in the direction from the second metallic piece 5 to the first metallic piece 4. Conversely, if an electric current is caused to flow through the electronic cooling element 3 in the opposite direction, the temperature of the first metallic piece 4 will become lower than the temperature of the second metallic piece 5, whereby the laser light 102 passing through the transparent medium 2 will be deflected downward or in the direction from the first metallic piece 4 to the second metallic piece 5.

In general, when a refractive index difference Δn is created between upper and lower surfaces of the transparent medium 2 having a refractive index temperature coefficient do/dT and a thickness D, and the refractive index of the transparent medium 2 changes linearly with respect to the position in the thickness direction, a deflection angle θ generated when the light travels the distance L through the transparent medium 2 can be expressed by Equation (1) shown below. This is described in the section of “Quantum Electronics” regarding light deflection due to electro-optic effects. According to this equation, it can be readily understood that, when the temperature difference ΔT between the upper and lower surfaces creates a refractive index difference Δn in the transparent medium 2, the deflection angle θ is given by Equation (2) shown below.

$$\begin{matrix}θ = L \frac{Δ n}{D} & ( 1 ) \\ θ = \frac{L}{D} \frac{d n}{d T} Δ T & ( 2 )\end{matrix}$$

Provided that an amount of heat Q needs to be transported through the transparent medium 2 having a thermal conductivity K and a cross section area S to maintain the temperature difference ΔT in a steady state, the temperature difference ΔT can be expressed by Equation (3) shown below. By using Equation (3), the deflection angle θ can be expressed by Equation (4). Of the factors on the right-hand side of Equation (4) that determine the deflection angle θ, the factors in the parentheses are determined by the material of the transparent medium 2. Thus, it can be understood that, to achieve a large deflection angle θ, it is preferred that the material has a high refractive index temperature coefficient dn/dT and a low thermal conductivity K. In the embodiment of the present invention, a synthetic quartz glass having a moderate refractive index temperature coefficient and a low thermal conductivity K and being excellent in resistance to laser damage, workability and availability is used as the material of the transparent medium 2.

$$\begin{matrix}Δ T = \frac{QD}{KS} & ( 3 ) \\ θ = \frac{LQ}{S} ( \frac{1}{K} \frac{d n}{d T} ) & ( 4 )\end{matrix}$$

The refractive index temperature coefficient dn/dT of synthetic quartz glass is about 10×10⁻⁶K⁻¹, and the propagation distance L is 10 mm in the illustrated embodiment, and thus, if the temperature difference ΔT is 10 K, the deflection angle θ can be calculated to be 0.5 mrad (nearly equal to 0.029 degrees).

In an actual experiment of the light deflector 1 of the illustrated embodiment, when electric power was supplied to the electronic cooling element 3 to heat the first metallic piece 4 such that the temperature difference ΔT between the first metallic piece 4 and the second metallic piece 5 was approximately equal to 10 degrees, the laser light 102 was deflected upward by about 0.45 mrad relative to the laser light 101. Conversely, when electric power was supplied to the electronic cooling element 3 to cool the first metallic piece 4 such that the temperature difference ΔT between the first metallic piece 4 and the second metallic piece 5 was approximately equal to 10 degrees, the laser light 102 was deflected downward by about 0.45 mrad.

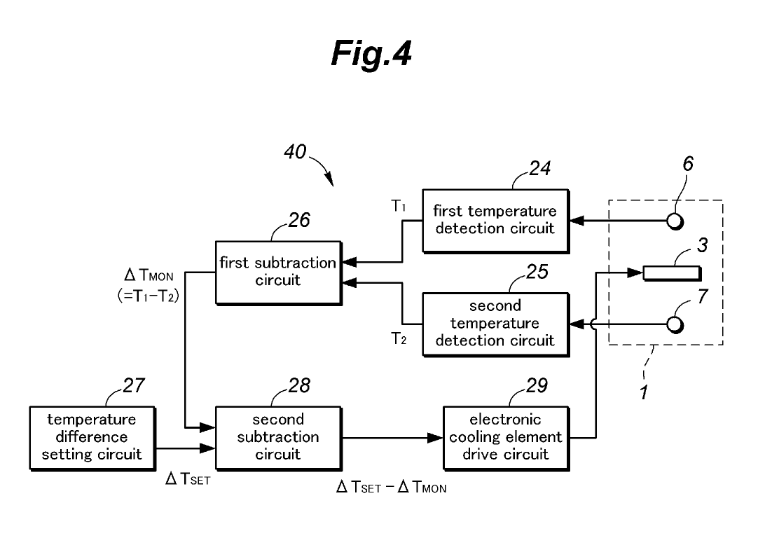

Next, with reference to the block diagram of FIG. 4, description will be given of a circuit structure of a controller 40 used to control the light deflector 1 shown in FIG. 1. In FIG. 4, the light deflector 1 shown in FIG. 1 as a whole is simply represented by a broken-line rectangular, and the first temperature sensor 6, the second temperature sensor 7 and the electronic cooling element 3, which relate to electric control of the light deflector 1, are depicted in the rectangular.

The temperature of the first metallic piece 4 measured by the first temperature sensor 6 is output as a voltage T₁ through a first temperature detection circuit 24. Similarly, the temperature of the second metallic piece 5 measured by the second temperature sensor 7 is output as a voltage T₂ through a second temperature detection circuit 25. These voltages T₁ and T₂ are input to a first subtraction circuit 26, which subtracts the latter from the former and outputs a difference voltage ΔT_{MON} (=T₁−T₂) obtained thereby.

On the other hand, a temperature difference setting circuit 27 outputs a voltage ΔT_{SET} that corresponds to a set value of the temperature difference ΔT between the first metallic piece 4 and the second metallic piece 5. The temperature difference setting circuit 27 may be a voltage divider circuit including a variable resistance for dividing an output voltage of a constant-voltage circuit and outputs the divided voltage as the output voltage ΔT_{SET}, whereby the voltage ΔT_{SET} can be set to correspond to a desired temperature difference ΔT by manually adjusting the variable resistance.

The output voltage ΔT_{SET} and the voltage ΔT_{MON} are input to a second subtraction circuit 28, which subtracts the latter from the former and outputs a difference voltage ΔT_{DIF}(=ΔT_{SET}−ΔT_{MON}) obtained thereby. An electronic cooling element drive circuit 29 supplies electric current to the electronic cooling element 3 according to the output voltage ΔT_{DIF} of the second subtraction circuit 28. When the output voltage ΔT_{SET} is higher than the voltage ΔT_{MON}, the electronic cooling element drive circuit 29 operates to heat the first metallic piece 4, and when the output voltage ΔT_{SET} is lower than the voltage ΔT_{MON}, the electronic cooling element drive circuit 29 operates to cool the first metallic piece 4, so that an absolute value of the difference voltage ΔT_{DIF} is reduced or the voltage ΔT_{MON} approaches the output voltage ΔT_{SET}.

The electronic cooling element drive circuit 29 performs PI control, which is a combination of proportional control (P control) and integral control (I control), according to the output voltage ΔT_{DIF} provided from the second subtraction circuit 28. It is to be noted that a response of the transparent medium 2 to heat is considerably slow compared to electric circuit behavior. Thus, the gain in the P control is set sufficiently small such that, when the output voltage ΔT_{SET} is changed to correspond to a desired temperature difference ΔT, the temperature difference ΔT does not overshoot during a transient period before a steady state is reached, and the control performed by the electronic cooling element drive circuit 29 mainly consists of the I control.

Usually, the temperature of the second metallic piece 5 is substantially the same as the temperature of the part to which the second metallic piece 5 is attached, and can be substantially equal to a room temperature at the lowest. If the first metallic piece 4 is cooled excessively in this state, dew condensation occurs. To prevent dew condensation at around an ordinary room temperature with moderate relative humidity, it is necessary to limit the temperature difference ΔT to about −10 K when the first metallic piece 4 is cooled. For the above reasons and to ensure that the maximum value (absolute value) of the deflection angle θ in the upward direction is substantial the same as the maximum value (absolute value) of the deflection angle θ in the downward direction, the controller 40 is configured to be able to control the temperature difference ΔT in a range from −10 K to +10 K. Further, the accuracy of control of the temperature difference ΔT by the controller 40 is 0.02 K at worst, and, the accuracy of control of the deflection angle θ is about 1 (one) μrad.

In the light deflector 1 combined with the controller 40 in the illustrated embodiment, the variable resistance in the temperature difference setting circuit 27 is manually adjusted to set the output voltage ΔT_{SET} corresponding to the temperature difference ΔT to be set. Thereby, the laser light 102 is deflected upward when the output voltage ΔT_{SET} has a positive value and is deflected downward when the output voltage ΔT_{SET} has a negative value. Further the deflection angle θ is proportional to the value of the output voltage ΔT_{SET}. It is supposed that in practice, a user adjusts the variable resistance in the temperature difference setting circuit 27 manually while monitoring one or more properties to be improved by use of the light deflector 1, such as the laser power and the beam profile.

In this embodiment, the transparent medium 2 used is rectangular in shape and has the low-reflectance dielectric multilayer coatings 2a and 2b formed on the end surface (incident surface) thereof through which the laser light 101 enters and on the end surface (exit surface) thereof from which the laser light 102 exits, respectively, whereby the light deflector 1 of a transmission type is formed. However, it is possible to achieve the light deflector 1 of a reflection type by slightly modifying the dielectric multilayer coatings 2a and 2b formed on the transparent medium 2 and/or the shape of the transparent medium 2.

The transparent medium 22 shown in FIG. 3B is made of the same material as that of the transparent medium 2 and has the same shape and dimensions as those of the transparent medium 2, but a dielectric multilayer coating 22a having a low reflectance is formed on the end surface (incident surface) thereof through which the laser light 101 enters and a dielectric multilayer coating 22b having a high reflectance is formed on the end surface thereof opposite to the incident surface, so as to form the light deflector 1 of a reflection type. In this case, if ΔT is the same, a deflection angle θ twice as large as when the transparent medium 2 is used can be obtained.

The transparent medium 23 shown in FIG. 3C is made of the same material as that of the transparent medium 2 and has the same width and thickness as those of the transparent medium 2, but the part thereof opposite to the end surface (incident surface) through which the laser light 101 enters is cut at an angle of 45 degrees relative the incident surface as shown in FIG. 3C and the cut surface is polished to make a total reflection surface 23c. The incident surface through which the laser light 101 enters and the exit surface from which the laser light 102 exits are formed with low-reflectance dielectric multilayer coatings 23a and 23b, respectively. In this case also, the light deflector 1 provided is of a reflection type.

Irrespective of whether the light deflector 1 to be provided is of a transmission type or a reflection type, the incident surface of the transparent medium 2 through which the laser light 101 enters may be angled such that the laser light 101 enters the incident surface at the Brewster angle and/or the exit surface of the same from which the laser light 102 exits may be angled such that the laser light 102 exits the exit surface at the Brewster angle. In such a case, there may be an advantage that there is no need to provide a low-reflectance coating on one or both of the incident and exit surfaces, though there is a constraint that the laser light 101 needs to be p-polarized relative to the incident surface of the transparent medium 2 and/or the laser light 102 needs to be p-polarized relative to the exit surface of the same. Further, there is an additional constraint that, when the laser light 101 is converging or diverging, it is necessary to use part of the laser light 101 that will result in a small astigmatism caused by incidence at the Brewster angle.

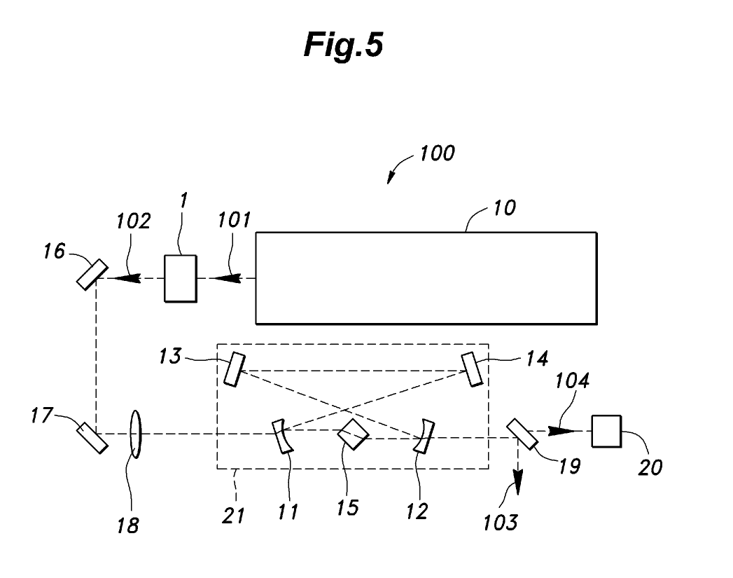

FIG. 5 is a schematic diagram showing a structure of a laser light source 100 including the light deflector 1 according to an embodiment of the present invention. The laser light source 100 serves as an external resonance-type second harmonic generating system, which performs wavelength conversion on the laser output from a single longitudinal mode laser 10 and outputs laser light having a wavelength that is half of the wavelength of the laser output from the single longitudinal mode laser 10.

The single longitudinal mode laser 10 operates in a continuous wave mode and outputs a single longitudinal mode laser light with a wavelength of 1064 nm. The light deflector 1 is arranged to deflect the laser light 101 output from the single longitudinal mode laser 10 in the direction perpendicular to the sheet of FIG. 5. The laser light 102 having passed through the light deflector 1 is guided by 45 degree mirrors 16 and 17 to a condenser lens 18, which performs an appropriate mode conversion on the laser light, and then, the laser light enters an external resonator 21.

The external resonator 21 is a figure-eight ring resonator including four laser mirrors 11, 12, 13 and 14. This type of ring resonator may also be referred to as a bow-tie type ring resonator. A surface of each of these laser mirrors 11-14 forming the resonator is formed with a dielectric multilayer coating, such that the laser mirror 13 and the laser mirror 14 have a reflectance of almost 100% at the wavelength of 1064 nm, the laser mirror 11 has a reflectance of 99% at the wavelength of 1064 nm, and the laser mirror 12 has a reflectance of almost 100% at the wavelength of 1064 nm and a reflectance not higher than 10% at the wavelength of 532 nm.

When laser light with a wavelength of 1064 nm is caused to enter this external resonator 21 via the laser mirror 11 from outside, the laser light with the wavelength of 1064 nm resonates in the external resonator 21, and the laser power in the external resonator 21 is enhanced by about 100 times. To achieve this resonance state in practice, it is necessary that the wavelength of the laser input from outside matches the resonance wavelength of the external resonator 21, and therefore, a means is necessary for precisely controlling the length of the external resonator 21 while monitoring the state of the resonator. However, such a means does not directly relate to the principle of operation of the present invention, and thus, component parts relating to such a means are not shown in FIG. 5.

A lithium triborate crystal (LiB₃O₅ crystal, simply referred to as an LBO crystal 15 hereinafter), which is an optical crystal exhibiting a secondary non-linear optical effect, is disposed on an optical path inside the external resonator 21, such that the laser light enters the LBO crystal 15 at the Brewster angle. The LBO crystal 15 is cut such that it satisfies an angle phase matching condition for generating a second harmonic wave, when the laser light having a wavelength of 1064 nm propagates in a direction corresponding to an angle of refraction resulting when the laser light with the wavelength of 1064 nm is incident at the Brewster angle.

In the aforementioned state where the laser power in the external resonator 21 has been enhanced, laser light having a wavelength of 532 nm, which is a second harmonic wave, is generated from the LBO crystal 15. The laser light with the wavelength of 532 nm is output from the external resonator 21 through the laser mirror 12. Further, part of the resonating laser light having the wavelength of 1064 nm leaks to the outside of the external resonator 21 through the laser mirror 12. The laser light output from the external resonator 21 impinges on a dichroic mirror 19.

The dichroic mirror 19 is provided with a dielectric multilayer coating exhibiting a low reflectance for laser light having a wavelength of 1064 nm and a high reflectance for laser light having a wavelength of 532 nm. Thus, laser light 103 having a wavelength of 532 nm output from the external resonator 21 is reflected by the dichroic mirror 19 and separated from laser light 104 having a wavelength of 1064 nm. The laser light 104 with the wavelength of 1064 nm that has leaked from the external resonator 21 is input to a beam position detector 20.

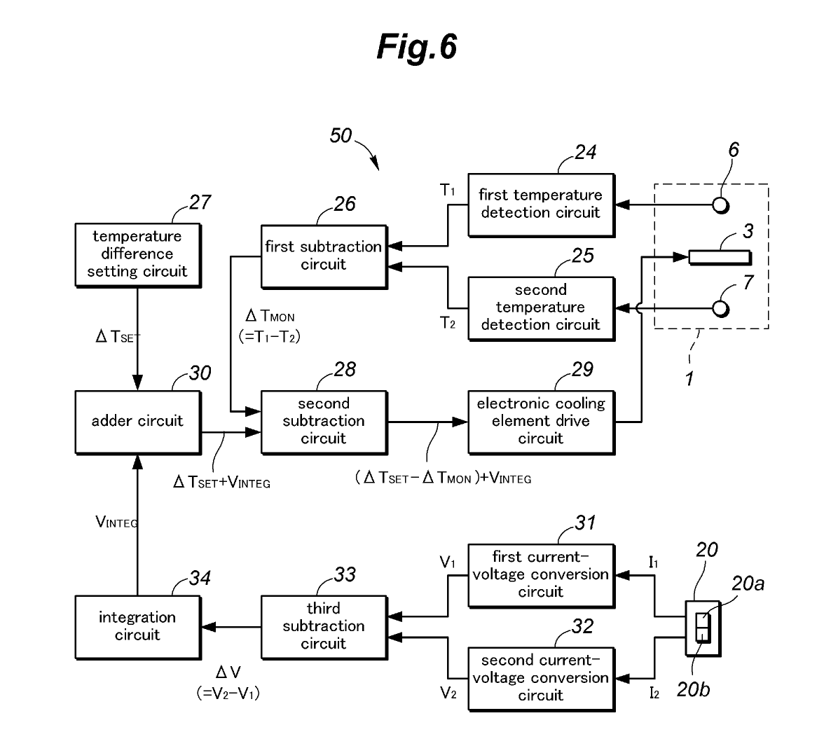

In this embodiment, a split photo detector having a pair of silicon photo diodes 20a and 20b (see FIG. 6) adjoining each other is used as the beam position detector 20, such that one (e.g., photo diode 20a) of the pair of silicon photo diodes is placed over the other (e.g., photo diode 20b). Thereby, the beam position detector 20 detects a one-dimensional change of the beam position in a vertical direction. The beam position detector 20 is adjusted such that the output current of the silicon photo diode 20a is the same as the output current of the silicon photo diode 20b when an overall optical condition of the laser light source 100 shown in FIG. 5 is optimal. It is also possible to use a position sensitive device (PSD) of a non-split type as the beam position detector 20.

In a case where the laser light enters the external resonator 21 along an ideal path to resonate in the resonator 21, the laser light 104 having the wavelength of 1064 nm that leaks from the external resonator 21 has a circular spatial pattern. However, when the laser light enters the external resonator 21 along a path inclined upward or downward relative to the ideal optical path, the spatial pattern of the laser light 104 becomes close to an ellipse and the center of intensity distribution in the spatial pattern is deviated upward or downward.

The upward or downward deviation of the spatial pattern of the laser light 104 is detected by the beam position detector 20, where a difference between electric signals from the pair of silicon photo diodes 20a and 20b is amplified appropriately as an error signal, which is added to the signal for setting the temperature difference ΔT in the controller 40 (FIG. 4) for the light deflector 1, whereby the optical axis is corrected automatically.

Next, with reference to the block diagram shown in FIG. 6, description will be made of a circuit structure of the controller 50 that performs the foregoing operation. The first temperature detection circuit 24, the second temperature detection circuit 25, the first subtraction circuit 26, the second subtraction circuit 28, and the electronic cooling element drive circuit 29 are the same as those shown in the block diagram of FIG. 4, and the connection of these circuits with the first temperature sensor 6, the second temperature sensor 7, and the electronic cooling element 3 also is the same as that shown in FIG. 4.

The temperature difference setting circuit 27 shown in FIG. 6 also is the same as that shown in FIG. 4 except that in FIG. 6, the output signal of the temperature difference setting circuit 27 is input to an adder circuit 30, which adds another signal to the output signal of the temperature difference setting circuit 27 and outputs the added signal to the second subtraction circuit 28.

Of the pair of silicon photo diodes 20a and 20b of the beam position detector 20, a first silicon photo diode 20a that is disposed on an upper side in an installed state into the laser light source 100 generates a photocurrent I₁ and a second silicon photo diode 20b that is disposed on a lower side in the installed state generates a photocurrent I₂, the photocurrent I₁ and the photocurrent I₂ being converted to an output voltage V₁ and an output voltage V₂ by a first current-voltage conversion circuit 31 and a second current-voltage conversion circuit 32, respectively. The output voltages V₁ is subtracted from the output voltage V₂ by a third subtraction circuit 33 to produce an output voltage ΔV (=V₂−V₁), which is provided to an integration circuit 34.

The integration circuit 34 integrates the received output voltage ΔV and outputs the integrated voltage as an output voltage V_{INTEG}. This output voltage V_{INTEG} is input to the adder circuit 30 as the aforementioned “another signal.” The adder circuit 30 outputs a signal corresponding to ΔT_{SET}+V_{INTEG} to the second subtraction circuit 28. The signal output from the second subtraction circuit 28 corresponds to (ΔT_{SET}−ΔT_{MON})+V_{INTEG}, and the electronic cooling element drive circuit 29 operates based on this signal.

In the following, description will be given of a concrete method of using the laser light source 100 combined with the controller 50. During manufacture of the laser light source 100, first, adjustment of the optical axis of the laser light source 100 is performed without operating the controller 50. Then, the controller 50 is put into operation except that only the electronic cooling element drive circuit 29 remains in an inoperative state. In this state, the position of the beam position detector 20 is adjusted such that the output voltage V_{INTEG} of the integration circuit 34 becomes zero. Further, the temperature difference setting circuit 27 is adjusted manually such that the output voltage ΔT_{SET} becomes zero. After the adjustment of these circuits is completed, the electronic cooling element drive circuit 29 is put into operation, whereby the adjustment of the system is completed. Once the foregoing adjustment is completed, the controller 50 operates automatically to maintain the optical axis in an optimally adjusted state.

Next, description will be made of a mode of operation when a distortion is created in the housing of the laser light source 100 for some reason, such that the laser light 104 having the wavelength of 1064 nm is shifted downward, for example. In this case, an amount of light entering the second silicon photo diode 20b becomes larger than an amount of light entering the first silicon photo diode 20a. As a result, the photocurrent I₂ generated by the second silicon photo diode 20b becomes larger than the photocurrent I₁ generated by the first silicon photo diode 20a, and the output voltage V₂ of the second current-voltage conversion circuit 32 becomes larger than the output voltage V₁ of the first current-voltage conversion circuit 31. Thus, the output voltage ΔV of the third subtraction circuit 33 has a positive value.

This voltage signal is integrated by the integration circuit 34 and output from the same as the output voltage V_{INTEG} having a positive value. The output voltage V_{INTEG} is transmitted via the adder circuit 30 and the second subtraction circuit 28 to the electronic cooling element drive circuit 29. If the electronic cooling element drive circuit 29 has been operating to heat the first metallic piece 4 when there was no distortion in the laser housing, the electronic cooling element drive circuit 29 operates to enhance the heating. If the electronic cooling element drive circuit 29 has been operating to cool the first metallic piece 4 when there was no distortion in the laser housing, the electronic cooling element drive circuit 29 operates to weaken the cooling of the first metallic piece 4, and further, the operation may be switched over from cooling to heating of the first metallic piece 4.

In either case, when the output voltage V_{INTEG} has a positive value, operation is performed to deflect the laser light 102 that has passed through the transparent medium 2 in the upward direction. This operation is continued to increase the deflection angle θ until the amount of light received by the first silicon photo diode 20a and the amount of light received by the second silicon photo diode 20b become equal to each other, and once such a state is reached, operation is performed to maintain the state.

It is to be noted, however, that, if an excessively large distortion is applied to the housing of the laser light source 100 when the set up location of the laser light source 100 is changed, for example, not only the laser light 103 with the wavelength of 532 nm may become unable to be output, but also the laser power of the laser light 104 with the wavelength of 1064 nm that impinges on the beam position detector 20 may become too weak to be used in performing the above-described control. In this state, the beam position deviation cannot be detected correctly by the beam position detector 20, and therefore, the control of optical axis by use of the light deflector 1 cannot be performed.

In such a case, it is possible to find an optimal value of the voltage ΔV_{SET} by forcibly setting the output voltage V_{INTEG} to zero and adjusting the variable resister of the temperature difference setting circuit 27 manually while monitoring the output of the laser light 103 having the wavelength of 532 nm. When the voltage ΔV_{SET} is set to an appropriate value, computation of the output voltage V_{INTEG} based on the signal output from the beam position detector 20 is restarted, such that, thereafter, the controller 50 automatically operates to correct a gradually generated deviation of the optical axis and maintain an optimally adjusted state of the optical axis, thereby allowing the laser light source 100 to maintain a stable output.

In this embodiment, correction of the optical axis is performed only in the direction perpendicular to the mounting surface of the laser light source 100 (more specifically, the mounting surface of the housing thereof). This is because the housing for accommodating the parts shown in FIG. 4 has a large size, and the deviation of the optical axis that may be caused when the housing is mounted to a device or an optical test bench or caused due to a change in the environmental temperature and/or a temporal change in the laser light source 100 itself tends to occur one-dimensionally, mainly in a direction perpendicular to the mounting surface of the housing.

In a case where the optical axis deviation is one-dimensional but is not in the vertical direction (or the direction perpendicular to the mounting surface), if the direction of the deviation of the optical axis is known beforehand, the light deflector 1 described above may be mounted such that the direction of light deflection caused by the light deflector 1 coincides with the direction of the deviation of the optical axis, and the beam position detector 20 may be arranged in an orientation in accordance with the arrangement of the light deflector 1. In a particular case where the deviation of the optical axis occurs mainly in the horizontal direction (or the direction along the mounting surface), the light deflector 1 may be rotated by 90 degrees about the optical axis such that the first metallic piece 4 and the second metallic piece 5 of the light deflector 1 are spaced apart from each other in the direction along the mounting surface, and the beam position detector 20 may be arranged in an orientation in accordance with the arrangement of the light deflector 1.

Further, when neither of the optical axis deviation in the vertical direction and the optical axis deviation in the horizontal direction is negligible, the light deflector 1 in the foregoing embodiment may be used in a pair and the beam position detector 20 may be implemented as a quadrant photo detector consisting of four photo detectors, such that the pair of light deflectors 1 are controlled based on a signal(s) obtained as a sum of or a difference between selected ones of the signals output from the four photo detectors.

In the foregoing embodiment, the light deflector 1 according to the present invention is disposed on a part of the laser optical path in the laser light source 100 where the resonance of the laser light does not take place. However, in a case of a laser apparatus including a long resonator and having a laser characteristic sensitive to a distortion of the housing, such as a Ti:sapphire laser operating as a mode-locked oscillator, it is possible to place the light deflector 1 inside the resonator and to control the light deflector 1 based on a signal appropriately indicating the optical axis deviation, such that the light deflector 1 is automatically controlled to maintain an adjusted state of the optical axis.

Although the present invention has been described in terms of preferred embodiments thereof, it is obvious to a person skilled in the art that the present invention is not limited by the embodiments and various alterations and modifications are possible without departing from the scope of the present invention which is set forth in the appended claims. For example, though the light deflector 1 is used in the laser light source 100 in the foregoing embodiment, the light deflector 1 may be used in another apparatus. Further, the concrete shape and/or arrangement of the component parts constituting the light deflector 1 and the laser light source 100 may be appropriately altered within the scope of the principle of the present invention. It is also to be noted that not all of the structural elements of the light deflector 1 and the laser light source 100 shown in the embodiment are necessarily indispensable, and they may be selectively used as appropriate.

When the light deflector of the present invention is used in a laser light source having a characteristic sensitive to a change in an adjustment state of the optical axis, it is made possible to perform the optical axis adjustment in the laser light source by electrically controlling the light deflector from outside, and therefore, it becomes unnecessary to open the cover of the laser light source to adjust the optical axis, which was necessary in the conventional laser light source. Further, when the optical axis adjustment becomes necessary due to a change in the environment temperature or temporal change of the laser light source itself, it is possible to automatically perform the adjustment. Thus, the present invention is particularly useful in improving convenience of the laser light source.

The contents of the original Japanese patent application(s) on which the Paris Convention priority claim is made for the present application as well as the contents of the prior art references mentioned in this application are incorporated in this application by reference.

1. A light deflector for deflecting a propagation direction of laser, comprising:
a first metallic piece and a second metallic piece spaced apart from each other; and
a transparent medium and an electronic cooling element disposed between the first metallic piece and the second metallic piece such that each of the transparent medium and the electronic cooling element is in contact with the first metallic piece and the second metallic piece,
wherein the electronic cooling element creates a temperature difference between the first metallic piece and the second metallic piece to vary a refractive index of the transparent medium.

2. The light deflector according to claim 1, wherein at least one of surfaces of the transparent medium other than two surfaces thereof in contact with the first metallic piece and the second metallic piece, respectively, has a dielectric multilayer coating formed thereon, the coating having a low reflectance for incident laser light.

3. The light deflector according to claim 1, wherein one of surfaces of the transparent medium other than two surfaces thereof in contact with the first metallic piece and the second metallic piece, respectively, has a dielectric multilayer coating formed thereon, the coating having a high reflectance for incident laser light.

4. The light deflector according to claim 1, wherein one of surfaces of the transparent medium other than two surfaces thereof in contact with the first metallic piece and the second metallic piece, respectively, is formed as a reflection surface that reflects laser light propagating in the transparent medium, and a surface of the transparent medium from which laser light reflected by the reflection surface is output has a dielectric multilayer coating formed thereon, the coating having a low reflectance for the laser light.

5. The light deflector according to claim 1, further comprising:
a first temperature sensor embedded in the first metallic piece;
a second temperature sensor embedded in the second metallic piece; and
an electric power controller configured to set a temperature difference between the first metallic piece and the second metallic piece, and control electric power supplied to the electronic cooling element such that a difference between a value measured by the first temperature sensor and a value measured by the second temperature sensor approaches the set temperature difference.

6. A laser light source including the light deflector according to claim 5, wherein the light deflector is disposed on an optical path of the laser light.

7. The laser light source according to claim 6, further comprising:
a beam position detector that detects a deviation of a position of laser light propagating on an optical path from a reference position; and
a control unit configured to control the light deflector based on a signal output from the beam position detector so as to reduce the deviation from the reference position.

8. The laser light source according to claim 7, further comprising:
a single longitudinal mode laser configured to output a continuous wave light; and
an external resonator configured to perform external resonator-type second harmonic generation using output light from the single longitudinal mode laser as a fundamental wave,
wherein the light deflector is disposed on an optical path between the single longitudinal mode laser and the external resonator.

9. The laser light source according to claim 8, wherein the beam position detector includes a photo detector that detects a position of part of the fundamental wave that leaks from the external resonator without being wavelength-converted, and
the control unit is configured to control the light deflector based on a signal from the photo detector corresponding an amount of deviation of the detected position from the reference position so as to reduce the amount of deviation.
